(19) United States
(12) Patent Application Publication
(10) Pub. No.: US 2007/0089682 A1
(43) Pub. Date: Apr. 26, 2007

(54) Integrated ocean wave harness unit

(76) Inventor: Reynaldo Mariansky, Sacramento, CA (US)

Correspondence Address: Reynaldo Mariansky, 4418 18th Avenue, Sacramento, CA, 95820, US

(21) Appl. No.: 11/256,898

(22) Filed: Oct. 24, 2005

(51) Int. Cl. A01K 1/03

(52) U.S. Cl. 119/419

(57) ABSTRACT

A system to transfer the up and down movement of waves and ocean surface movement into rotational movement to power machinery to produce electricity. The system includes a portable framework cage anchored at sea bed containing a floating unit. Inside said cage includes at least two pairs of rack bars and a plurality of channels were friction roller members of the floating unit will slide. Two clutched gears attached parallel on the driving gear shaft of an air compressor mounted on top of the floating tank, meshing each gear at corresponding rack bar inside the cage transferring the up and down motion of the floating unit into rotational action on an air compressor. Compressed air is sent through a pipeline containing a one-way valve into the floating tank member of said unit. Compressed air stored inside the floating tank is sent through a flexible tube to a main pipeline to a warehouse. Compressed air provided by hundreds of said units will be used to power machinery producing electricity to extract hydrogen from water.

### CROSS-REFERENCE TO RELATED APPLICATION

Not Applicable

### FEDERALY SPONSORED RESEARCH

Not Applicable

### SEQUENCE LISTING OR PROGRAM

Not Applicable

### BACKGROUND OF THE INVENTION

This invention relates to a system that harnesses the power of ocean waves. The need for more and more energy, along with the diminishment of nonrenewable fuel sources, has encouraged hundreds of prior art that has attempted to harness the untamed power of the ocean.

### BACKGROUND

The greatest obstacle that almost all prior art has faced is finding the appropriate place to put any device of this nature to ensure its proper functionality, for example, so its not out of water during low tides, under water during high tides or worse yet, washed away by violent waves. In addition, devices that use underwater turbines can get stuck with seaweed, sand, and other debris, while corrosive salt water easily destroys metal. Also, many other systems that rely on compressed air to power turbines do not function well because they lack the necessary large volumes of air. For example, U.S. Pat. No. 6,574,957B2 discloses a system where a float pushes up a pivot arm which is attached to a piston. This piston sends air to a reservoir to be transferred to power a turbine, not taking into account the large quantities of air needed to power such a turbine. Furthermore, large structures are too expensive and expose more surface area to the overwhelming force of the violent sea, such as U.S. Pat. No. 5,708,305. This patent discloses a large and cumbersome apparatus for obtaining energy from wave action, which consists of a multi-tiered structure with pivot arms which has a float and paddle on one end while the opposite end is attached to an air pump. Other problems can be seen in U.S. Pat. No. 5,169,786, which describes an embodiment device where pilasters are embedded in the sea floor. A float moves up and down transferring that energy as a means to power a DC generator first and then compresses hydrogen and/or oxygen gas, leading to problems in regulating the energy current. Finally, there are many systems that place electrical cables underwater, making it difficult to access in case of needed repairs.

### SUMMARY

This invention relates to means of utilizing ocean wave motion operated by compressed air and the principal objective is to provide effective and cost efficient means to compress air thereby producing a cheap DC current needed to extract hydrogen through water electrolysis. This invention consists of an energy receiving member which responds to the up and down movement of waves and transfers such movement to a rack and pinion mounted on a driving gear box shaft member of an air compressor. This device can be placed anywhere along the coastline, whether there are low or high waves.

### BRIEF DESCRIPTION OF DRAWINGS

FIG. 1A Shows a view of the framework or cage.

FIG. 1B Shows a transversal view of a beam and pile to show how it will be reinforced.

FIG. 2 Shows inside view of the cage showing how and where the rack bars are placed and a clutched pinion.

FIG. 3 Shows side view of the floating tank in case inside a supporting structure, a base that carries two air compressors (also shows an alternative to rack and pinion that can be substituted by industrial chains and gears).

FIG. 4 Shows top view of a framework and a floating unit showing how to lower down or can be pushed out by waves or mechanical means.

FIG. 5 Shows side view of tank and compressor unit inside cage.

### DESCRIPTION OF INVENTION

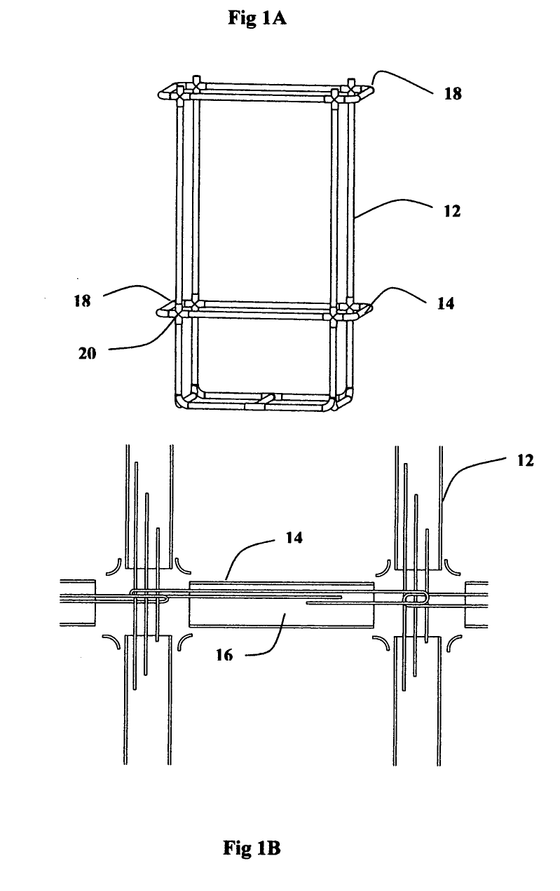

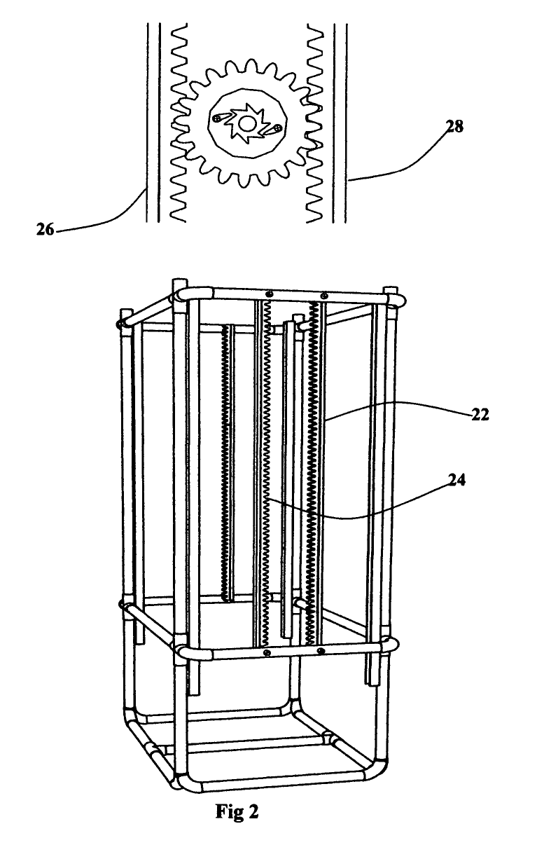

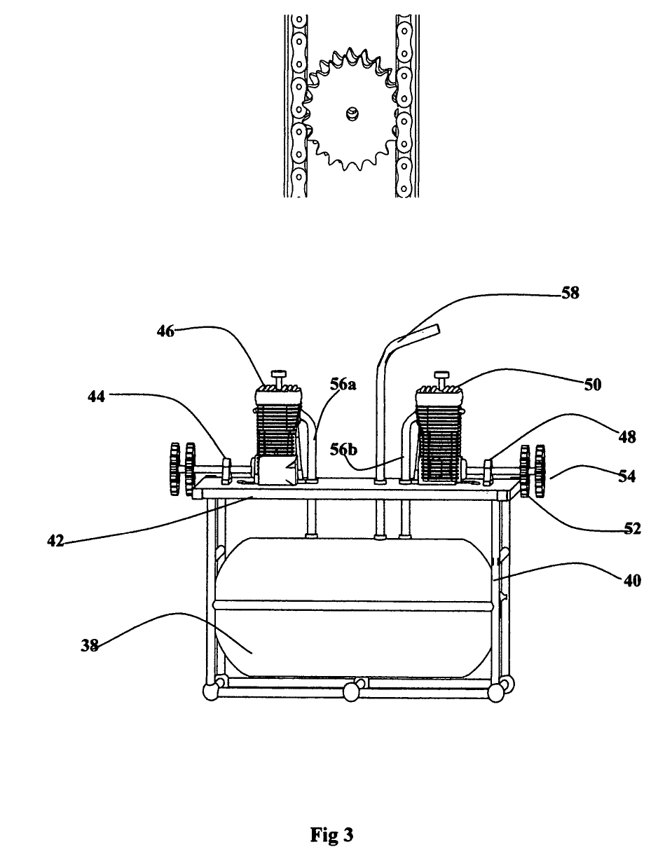

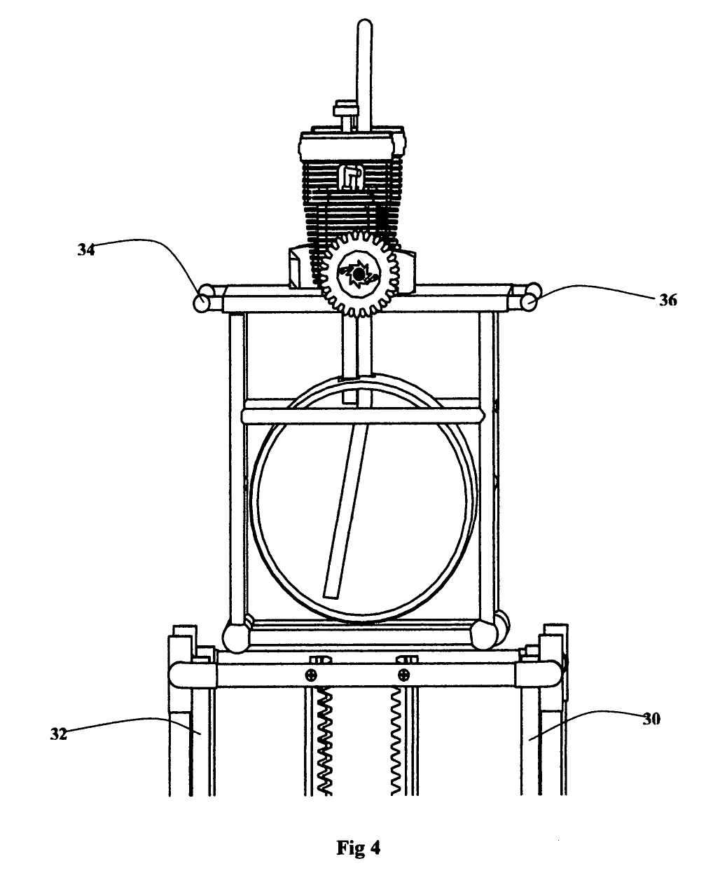

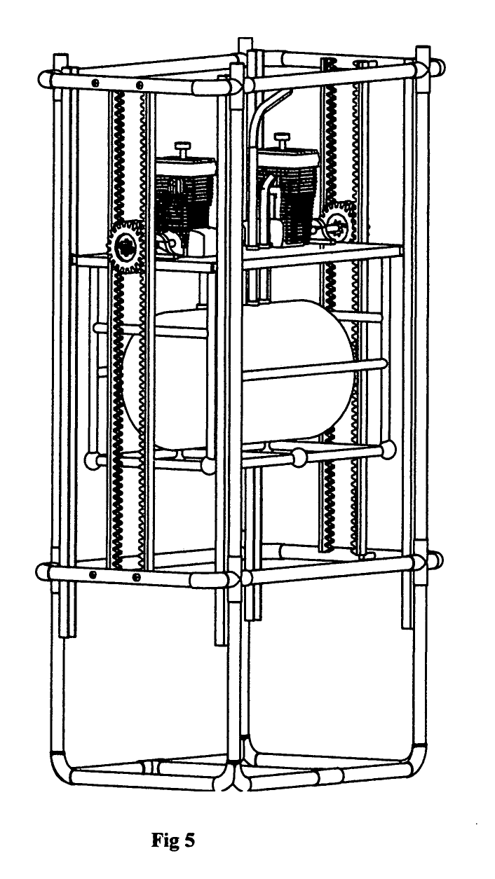

Preferred embodiment referring to the drawing showing more detail of this wave harnessing system of the present invention, which consists of two main embodiments.
1. A structure or framework with the shape of an elongated rectangular cage FIG. 1A consisting of a plurality of vertically disposed columns or piles 12, a plurality of disposed horizontal beams 14 forming an elongated rectangular cage. FIG. 1B Plastic tubes and pipes 14 reinforced with iron bars 16 filled with concrete will serve as columns and beams, connecting to each other through elbows 18, cross joints 20 and other connecting means for assembly of said cage. Only beams that will be placed horizontally are reinforced prior to be assembled FIG. 1B. Starting bottom up, the construction of said cage with horizontal beams filled with concrete and iron bars connecting with vertical tubes and iron bar passing down through a tube in a half O protruding from horizontal beams in which concrete is poured down into said plastic tube, resulting in a solid structure or cage. Inside said cage and on the narrower side are two pairs of rack bars FIGS. 2, 22, 24, 26, and 28 which are bolted on to said cage (these rack bars can be substituted by industrial chains or even a flat rough plate or a channel). At least two pairs of channels FIG. 4, 30 and 32 are bolted on said columns or piles on which friction rollers 34 and 36 will slide.
2. The power unit FIG. 3 consisting of floating tank 38 in case with bracket 40 and beams to create a buffer zone between tank 38 and a base or platform 42. Gearbox 44 (represented by a small rectangular shape) and air compressor 46 are bolted at one end on said platform 42. Second gearbox 48 (represented by a small rectangular shape) and air compressor 50 are bolted on the opposite end of said platform. Each gearbox 44 and 48 are attached with two clutched pinions 52 and 54 that will mesh with rack bars FIG. 2, 22 and 24 inside the cage. At the moment this power unit is lowered down into the cage, all four pinions will mesh with a rack bar. On its way down, two clutched pinions will lock and rotate the driving shaft of both and thus power the air compressor. When waves push the floating tank up those two pinions disengage and the other two lock keeping the rotation in the same direction. Air from both air compressors is sent into the floating tank through two lines 56a and 56b. Air coming out of tank 38 through a line 58 is sent to a main pipeline through a flexible tube (not shown). Air from said unit and form many others will be sent to a power plant to be used to power a two-cycle engine that will drive a DC generator producing electricity to extract hydrogen form water.

### CONCLUSION

This invention is a compact unit with a tank that provides buoyancy and stores energy as compressed air, carries two air compressors, and can move freely up and down. This device overcomes the greatest dilemma of prior art which is finding an adequate location. This device can be placed anywhere where there are waves, making this invention unique in this field. This compact unit moves freely up and down in a cage or framework. This structure, assembled by plastic tubes and existing connecting accessories, is reinforced with iron bars and concrete making it highly resistant to corrosion. This structure is embraced with two pairs of rack bars (that can be substituted by industrials chains) and many channels to house friction rollers from floating unit. The structure is lowered down on the ocean floor at low tide where there are still small waves. A compact power unit consisting of a tank mounted with a platform on which two air compressors are bolted on to said platform. At the moment this unit is lowered down inside the framework all pinions will mesh with rack bars bolted inside said framework or cage, one pinion in each, will lock its clutch and force a rotational movement of each air compressor. When waves push this unit up the second pair of pinions will lock its clutch and keep the movement in the same direction. Compressed air from both compressors is sent to the floating tank unit. Air from this unit and many others is sent through a main pipeline to a power plant. Such power plant can be set on shore or on top of a battery of said structures. A battery of structures will provide the foundation to build a warehouse or power plant. A sheet of grill or other means of covering the whole area will create a platform or deck on which to work or expand the annexation of more units. A two-cycle engine powered by compressed air will power a DC generator, producing electricity by the well know process of electrolysis, to thus obtain hydrogen from water. Slim round columns from said structures and many others supporting each other will give this invention a high grade of success dealing with many of the ocean's threats. Where cost is a hurdle in prior art, this invention presents a system that can be put together with low cost materials and is easily and cheaply replaced.

What is claimed:

1. A structure or framework consisting of a plurality of vertically disposed columns or piles and beams, and a plurality of horizontally disposed beams, assembled as an elongated rectangular cage.

2. Said columns and beams made up of plastic tubes and pipes with an inner core reinforced with iron bars and concrete connected to each other with elbows, T's, and a variety of connecting means.

3. A portable cage embraced with channels, where friction rollers members of the floating unit will slide.

4. Portable open cage embraced with at least two pairs of rack bars (can be substituted by two pairs of chains).

5. A power unit, one unit with means for buoyancy and serving as energy storage carrying on top machinery required to compress air, all embodied as a floating unit.

6. A twin set of clutched pinions mounted parallel up on a driving gear box shaft that can move up and down between two rack bars, on which said pinion will mesh and transfer such movement in rotational action on an air compressor.
